(19) United States
(12) Patent Application Publication
(10) Pub. No.: US 2025/0357061 A1
(43) Pub. Date: Nov. 20, 2025

(54) ELECTROMAGNETIC RELAY

(71) Applicant: DENSO ELECTRONICS CORPORATION, Anjo-city (JP)

(72) Inventor: Taisuke KATAKAMI, Anjo-city (JP)

(21) Appl. No.: 19/291,783

(22) Filed: Aug. 6, 2025

Related U.S. Application Data
(63) Continuation of application No. PCT/JP2024/005365, filed on Feb. 15, 2024.

(30) Foreign Application Priority Data
Feb. 28, 2023 (JP) 2023-030225

(51) Int. Cl. H01H 50/02; H01H 50/44; H01H 50/54

(52) U.S. Cl. CPC H01H 50/023; H01H 50/44; H01H 50/546

(57) ABSTRACT

An electromagnetic relay includes a case having an accommodating space that is open to an outside through an opening, and a base fitted into the case and closing the opening. The case or the base has a flame extinguishing hole for extinguishing a flame. The accommodating space accommodates a coil, a pair of fixed contactors and a movable contactor, and communicates with the outside through the flame extinguishing hole. A sealing member covers the flame extinguishing hole to make the accommodating space a sealed space and suppress intrusion of gas from the outside to an inside of the accommodating space. A moisture-absorbing member is arranged in the accommodating space to absorb water vapor within the accommodating space.

### CROSS REFERENCE TO RELATED APPLICATIONS

The present application is a continuation application of International Patent Application No. PCT/JP2024/005365 filed on Feb. 15, 2024, which designated the U.S. and claims the benefit of priority from Japanese Patent Application No. 2023-030225 filed on Feb. 28, 2023. The disclosures of all the above applications are incorporated herein.

### TECHNICAL FIELD

The present disclosure relates to an electromagnetic relay for opening and closing an electric circuit.

### BACKGROUND

Conventional electromagnetic relays have a structure comprising a case with an accommodating space that is open to the outside through an opening, and a base that fits into the case and closes the opening.

### SUMMARY

An electromagnetic relay according to an aspect of the present disclosure includes a case, a base, a coil, a pair of fixed contactors, movable contactor, a sealing member and a moisture-absorbing member. The case has an accommodating space that is open to an outside through an opening. The base is fitted into the case and closes the opening. The coil is arranged in the accommodating space and configured to generate electromagnetic force when energized. The pair of fixed contactors each has one end arranged in the accommodating space and fixed to the base. The movable contactor is arranged in the accommodating space and configured to be driven by the electromagnetic force generated by the coil to make or break contact with the pair of fixed contactors. The case or the base has a flame extinguishing hole configured to extinguish a flame. The accommodating space communicates with the outside through the flame extinguishing hole. The sealing member covers the flame extinguishing hole to make the accommodating space a sealed space and suppress intrusion of gas from the outside to an inside of the accommodating space. The moisture-absorbing member is arranged in the accommodating space to absorb water vapor within the accommodating space.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a cross-sectional view illustrating an electromagnetic relay according to a first embodiment.

FIG. 2 is a view taken in the direction of arrow II of FIG. 1.

FIG. 3 is a cross-sectional view taken along line III-III of FIG. 1.

FIG. 4 is a perspective view of the electromagnetic relay shown in FIGS. 1 to 3.

FIG. 5 is a partial cross-sectional view of a case portion taken along line V-V of FIG. 4.

FIG. 6 is a cross-sectional view illustrating an electromagnetic relay according to a second embodiment.

FIG. 7 is a cross-sectional view taken along line VII-VII of FIG. 6.

FIG. 8 is a partial cross-sectional view of a case portion in an electromagnetic relay according to a third embodiment.

### DETAILED DESCRIPTION

According to a first comparative example, electromagnetic relays have a structure comprising a case with an accommodating space that is open to the outside through an opening, and a base that fits into the case and closes the opening. The accommodating space is in communication with the outside through a ventilation hole formed in the case or at the fitting portion between the case and the base. By having this ventilation hole, any flame generated in the accommodating space is extinguished as it passes through the ventilation hole, because the flame loses heat to the base and the terminals.

Additionally, according to a second comparative example, in order to prevent the infiltration of siloxane gas into the interior of a micro switch, a rubber cap is mounted on the sliding part of the push button attached to the case, and the surface of the rubber cap is coated with a gas barrier layer.

However, as shown in the first comparative example, in the structure where the interior and exterior of the case are connected through the ventilation hole, although flame extinguishing is possible, when using an electromagnetic relay in an environment where siloxane gas may be generated, the siloxane gas can infiltrate the accommodating space through the ventilation hole. Therefore, there is a possibility of causing poor contact conductivity due to the influence of the siloxane gas.

On the other hand, in the second comparative example, by coating with a gas barrier layer to make the accommodating space inside the case a sealed space, it is conceivable to suppress the infiltration of siloxane gas into the accommodating space from the outside. However, if the accommodating space is made into a sealed space, the escape of water vapor that has evaporated from internal components and the like within the accommodating space to the outside of the case is hindered. Therefore, in sub-zero environments, the water vapor may freeze on the contact surfaces, potentially causing poor contact conductivity.

According to the present disclosure, an electromagnetic relay is capable of extinguishing flames within an accommodating space and suppressing poor contact conductivity caused by influence of siloxane gas and influence of water vapor present within the accommodating space.

An electromagnetic relay according to a first aspect of the present disclosure includes a case, a base, a coil, a pair of fixed contactors, movable contactor, a sealing member and a moisture-absorbing member. The case has an accommodating space that is open to an outside through an opening. The base is fitted into the case and closes the opening. The coil is arranged in the accommodating space and configured to generate electromagnetic force when energized. The pair of fixed contactors each has one end arranged in the accommodating space and fixed to the base. The movable contactor is arranged in the accommodating space and configured to be driven by the electromagnetic force generated by the coil to make or break contact with the pair of fixed contactors. The case or the base has a flame extinguishing hole configured to extinguish a flame. The accommodating space communicates with the outside through the flame extinguishing hole. The sealing member covers the flame extinguishing hole to make the accommodating space a sealed space and suppress intrusion of gas from the outside to an inside of the accommodating space. The moisture-absorbing member is arranged in the accommodating space to absorb water vapor within the accommodating space.

In this manner, by covering the flame extinguishing hole with the sealing member, the intrusion of siloxane gas or flammable gas can be suppressed even in environments where siloxane gas or flammable gas is present around the electromagnetic relay. Therefore, it is possible to suppress poor contact caused by the influence of siloxane gas and reduce the possibility of ignition of flammable gas. Additionally, since the flame extinguishing hole is provided, even if flammable gas is present in the accommodating space and the flammable gas ignites and generates flames, the flames can be extinguished as they lose heat upon entering the flame extinguishing hole, preventing the flames from sustaining. Therefore, it is possible to prevent the flames from propagating to the outside of the electromagnetic relay. Furthermore, since the accommodating space is sealed as an enclosed space by the sealing member, if water vapor is generated inside the accommodating space, it cannot be released to the outside. However, since the moisture-absorbing member is provided within the accommodating space, the moisture-absorbing member can absorb the water vapor. As a result, even in sub-zero environments, the moisture-absorbing member prevents water vapor from freezing, thereby preventing poor contact conductivity.

According to a second aspect of the present disclosure, the sealing member is a gas barrier film that is attached to the case or the base, which has the flame extinguishing hole, and covers the flame extinguishing hole.

In this manner, the sealing member can be constituted by the gas barrier film, and by being attached to the case or the base where the flame extinguishing hole is formed, it can cover the flame extinguishing hole.

According to a third aspect of the present disclosure, the sealing member has a bottomed cylindrical shape with a hollow portion, and has a female screw thread formed on an inner wall surface defining the hollow portion. The case or the base, which has the flame extinguishing hole, has a support wall around the flame extinguishing hole, and the support wall has a male screw thread corresponding to the female screw thread. The sealing member is fastened to the support wall via the male screw thread and the female screw thread, and the flame extinguishing hole is covered by the sealing member.

In this manner, the sealing member has the bottomed cylindrical shape having the female screw thread and the support wall having the male screw thread is formed around the flame extinguishing hole. Thus, the sealing member can be fastened to the support wall by screwing it in, thereby covering the flame extinguishing hole with the sealing member.

According to a fourth aspect of the present disclosure, the moisture-absorbing member is a moisture-absorbing material that is applied to wall surfaces of the case and the base defining the accommodating space.

In this manner, the moisture-absorbing member can be provided by applying the moisture-absorbing material to the wall surfaces of the case and the base that define the accommodating space. Accordingly, it becomes unnecessary to secure additional space that would be required if the moisture-absorbing member were a separate component.

According to a fifth aspect of the present disclosure, the moisture-absorbing member is a moisture-absorbing material that is applied to inner wall surfaces of the case and the base defining the accommodating space. The moisture-absorbing material is not provided in a portion of the inner wall surfaces that surrounds a contact portion including a fixed contact of the fixed contactors and a movable contact of the movable contactor. The moisture-absorbing material is provided in a portion of the inner wall surfaces that surrounds the coil and is different from the portion surrounding the contact portion.

Thus, a region where the moisture-absorbing member is placed and a region where the moisture-absorbing member is not placed can be provided in the accommodating space. When water vapor is generated within the accommodating space, it is possible to create a region with high water vapor concentration and a region with low water vapor concentration. As a result, a water vapor concentration gradient is formed within the accommodating space, allowing the water vapor to diffuse from the region with higher concentration to the region with lower concentration. Therefore, the retention of water vapor near the contact portion can be prevented. Consequently, even in sub-zero environments, the formation of ice from water vapor can be prevented, thereby suppressing poor contact conduction.

The embodiments of the present disclosure will be described below with reference to the drawings. In the following embodiments, parts that are identical or equivalent to those described in preceding embodiments are denoted by the same reference numerals, and their descriptions may be omitted. Additionally, in each embodiment, when only a part of the components is described, the components described in the preceding embodiments can be applied to the other parts of the components.

### First Embodiment

An electromagnetic relay according to the present embodiment is used, for example, in an electric vehicle equipped with a fuel cell. The fuel cell is a power generator that utilizes hydrogen gas, which is a flammable gas.

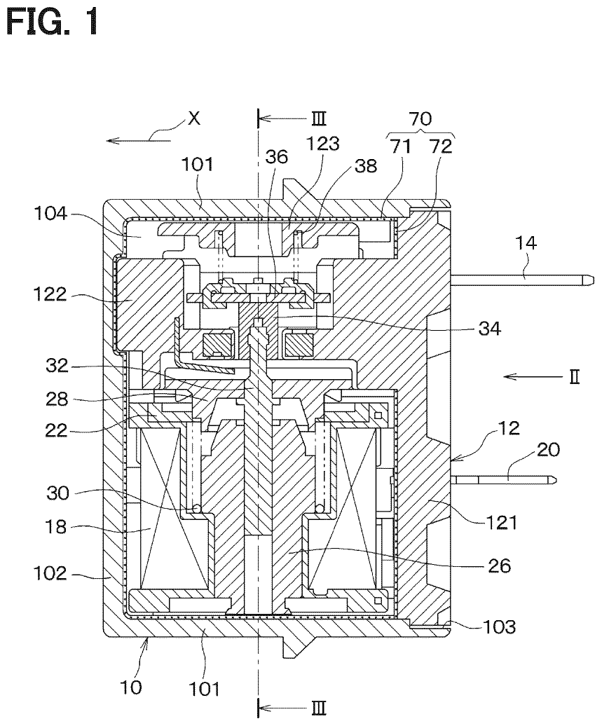

As shown in FIGS. 1 to 5, the electromagnetic relay according to the present embodiment includes a resin case 10. The case 10 has four side walls 101 and one case bottom 102, with a case opening 103 provided on one surface opposite the case bottom 102, forming a bottomed quadrangular tube shape. Inside the case 10, an accommodating space 104 is formed, and this accommodating space 104 is open to the outside through the case opening 103.

A resin base 12 includes a base bottom 121 that fits into the case 10 and closes the case opening 103, a base body 122 that protrudes from the base bottom 121 toward the case bottom 102, and a base spring seat 123 that holds a contact pressure spring 38, which will be described later. The accommodating space 104 is defined by the case 10 and the base bottom 121. The base 12 is formed by insert molding using a pair of stators 14, which will be described later, as inserts.

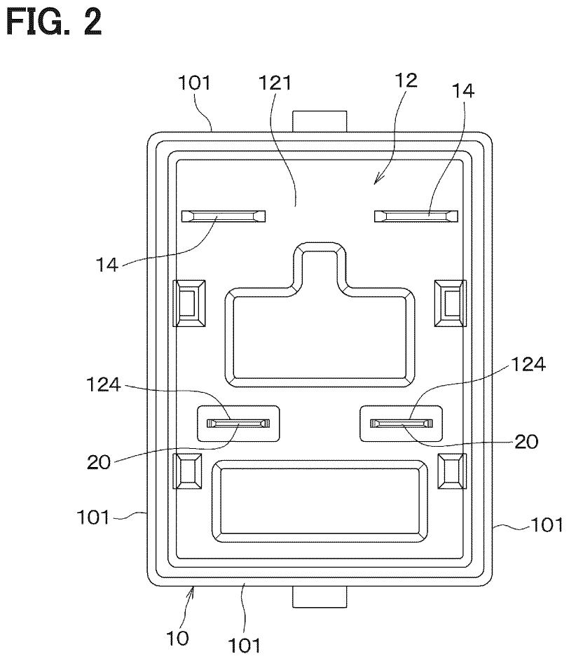

As shown in FIG. 2, the base bottom 121 has two terminal insertion holes 124 into which a pair of coil terminals 20, which will be described later, are inserted.

When assembling the base 12 to the case 10, the base 12 is inserted into the case 10 by moving the base 12 relative to the case 10 from the right side to the left side in FIG. 1, as indicated by arrow X. Hereinafter, the insertion direction of the base 12 when assembling the base 12 to the case 10 is referred to as a base insertion direction X. The case 10 and the base 12 are joined by a snap-fit mechanism (not shown).

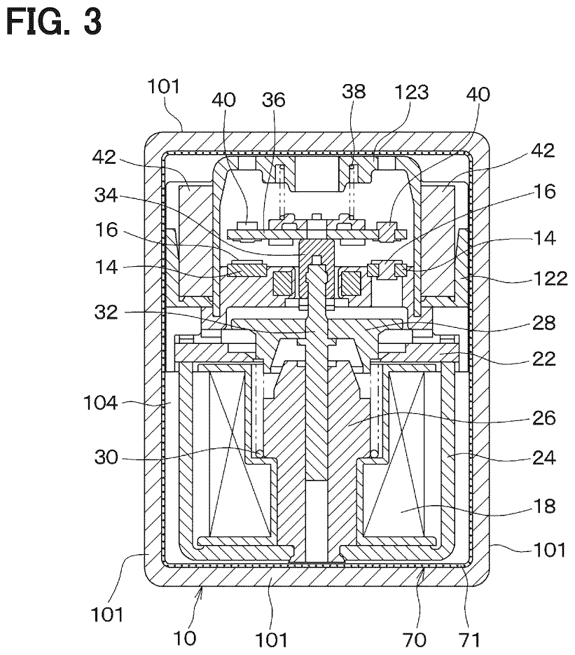

As shown in FIG. 3, the pair of stators 14 made of conductive metal plates are fixed to the base 12. Each stator 14 has one end fixed to the base body 122 and is positioned within the accommodating space 104, while the other end of each stator 14 protrudes to the outside. A fixed contact 16 made of conductive metal is riveted and secured to the end of a stator 14 protruding in the accommodating space 104. The other end of the stator 14 protruding to the external space is connected to an external electrical circuit (not shown). The stator 14 and the fixed contact 16 together constitute a fixed contactor.

A cylindrical coil 18, which generates electromagnetic force when energized, is arranged in the accommodating space 104. The pair of coil terminals 20 made of conductive metal are connected to this coil 18.

The coil terminals 20 are inserted into terminal insertion holes 124, with their ends protruding outside the electromagnetic relay. More specifically, the coil terminals 20 are press-fitted into the terminal insertion holes 124, ensuring that there is no gap between the coil terminals 20 and the inner wall surfaces defining the terminal insertion holes 124. The coil terminals 20 are connected to an ECU (not shown) via an external harness, and the coil 18 is energized through this external harness and the coil terminals 20.

A disc-shaped plate 22 made of ferromagnetic metal material is arranged between the coil 18 and the base body 122. A yoke 24, which is made of ferromagnetic metal material, is positioned adjacent to the side of the coil 18 that faces away from the base body 122, as well as along the outer periphery of the coil 18. The plate 22 and the yoke 24 are fixed to the base 12.

In the inner peripheral space of the coil 18, a cylindrical fixed core 26 made of ferromagnetic metal material is arranged, and the fixed core 26 is held by the yoke 24.

A disc-shaped movable core 28 made of ferromagnetic metal material is arranged between the base body 122 and the plate 22. Additionally, between the coil 18 and the movable core 28, a return spring 30 is arranged to bias the movable core 28 in a direction away from the fixed core 26.

When the coil 18 is energized, the electromagnetic force generated by the coil 18 causes the movable core 28 to be attracted toward the fixed core 26 against the return spring 30. The plate 22, yoke 24, fixed core 26, and movable core 28 constitute the magnetic path for the magnetic flux induced by the coil 18.

A metal shaft 32 passes through and is fixed to the movable core 28. One end of the shaft 32 extends in the direction away from the fixed core 26, and the end of this one end of the shaft 32 is fitted and fixed to an insulating bushing 34 made of resin with excellent electrical insulating properties. The other end of the shaft 32 is slidably inserted into the fixed core 26.

In the accommodating space 104, a mover 36 made of a conductive metal plate is arranged. Between the mover 36 and the base spring seat 123, the contact pressure spring 38 is arranged to bias the mover 36 toward the insulating bushing 34. Two movable contacts 40 made of conductive metal are riveted and fixed to the mover 36 at positions facing the two fixed contacts 16. The mover 36 and the movable contacts 40 constitute a movable contactor.

In the recess of the base body 122, a pair of permanent magnets 42 are arranged to form a magnetic field in the contact-separation areas where the fixed contacts 16 and the movable contacts 40 make and break contact, thereby stretching the arc generated between the fixed contacts 16 and the movable contacts 40. These permanent magnets 42 are arranged facing each other along the alignment direction of the pair of contact-separation areas (the left-right direction in FIG. 3).

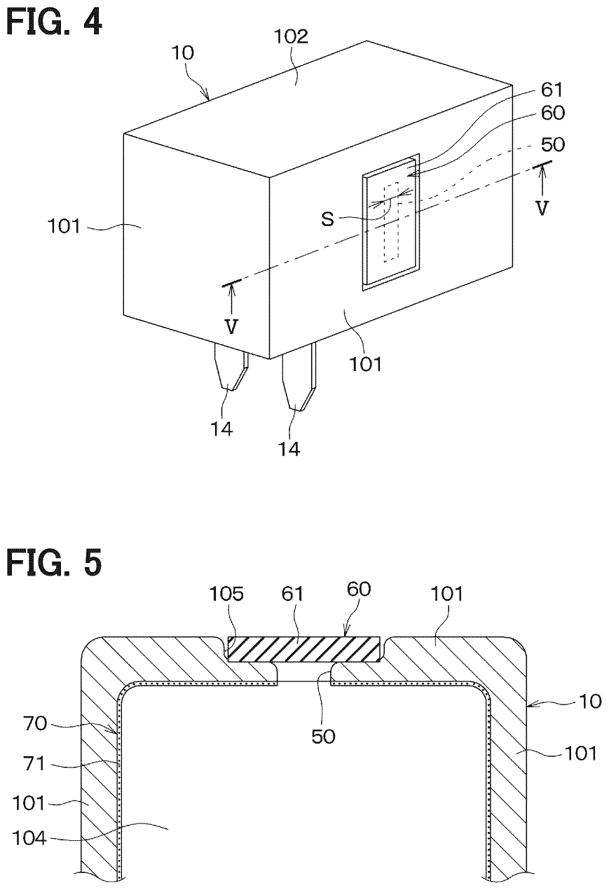

Additionally, as shown in FIGS. 4 and 5, a flame extinguishing hole 50 is formed in the case 10, and a sealing member 60 is arranged to cover the flame extinguishing hole 50. Although it is possible to create a structure where the accommodating space 104 is sealed solely by the case 10 and the base 12 without forming a flame extinguishing hole 50 in the case 10, this would require the case 10 and the base 12 to be made of metal or ceramics and necessitate welding, thereby reducing the flexibility in material selection and manufacturing processes. Therefore, a structure in which the flame extinguishing hole 50 is provided in the case 10 is adopted here. By covering the flame extinguishing hole 50 with the sealing member 60, the accommodating space 104 is sealed.

The flame extinguishing hole 50 connects the accommodating space 104 (see FIG. 1) with the exterior, and in this embodiment, the flame extinguishing hole 50 is provided in the case 10. More specifically, the flame extinguishing hole 50 is an elongated rectangular slit that penetrates the side wall 101 of the case 10. The dimension S of the short side of the flame extinguishing hole 50 is set to a size that can extinguish the flame entering the flame extinguishing hole 50. For example, the width dimension of the slit constituting the flame extinguishing hole 50 may be set to 0.3 mm or less.

The flame extinguishing hole 50 may also be formed in the base 12 or provided as a groove at the contact surface between the case 10 and the base 12. However, when the flame extinguishing hole 50 is formed in the case 10 as in the present embodiment, the position of the flame extinguishing hole 50 can be set without being restricted by the position of the terminal insertion holes 124 as shown in FIG. 2, thereby improving the design flexibility. Additionally, since the dimensions of the flame extinguishing hole 50 can be set without being affected by the width dimensions of the coil terminals 20, it is easy to ensure the function of extinguishing the flame and to secure the predetermined passage area.

Additionally, the sealing member 60 is provided on the outer wall surface of the case 10 and seals the flame extinguishing hole 50 by covering the flame extinguishing hole 50, thereby making the accommodating space 104 a sealed space. Thus, by making the accommodating space 104 a sealed space, the intrusion of siloxane gas or flammable gas from outside the case 10 into the accommodating space 104 can be prevented. However, on the inner wall surface of the case 10, the flame extinguishing hole 50 remains as a recess. Therefore, even if flammable gas is contained within the accommodating space 104 and the flammable gas is ignited by an arc, when the flame enters the flame extinguishing hole 50 that remains as a recess, the heat is absorbed by the case 10, causing the flame to be extinguished as it cannot be sustained.

Specifically, in this embodiment, the sealing member 60 includes a gas barrier film 61 that prevents gas present outside the case 10 from entering the accommodating space 104. As the gas barrier film 61, for example, an EVAL film or a nylon film can be used. “EVAL” is a registered trademark.

A recessed portion 105, which is recessed from the outer wall surface of the case 10 more than the surrounding outer part of the outer wall surface, is formed around the flame extinguishing hole 50 of the case 10. The gas barrier film 61 is fixed within this recessed portion 105, for example, using an adhesive. The depth of the recessed portion 105 and the thickness of the gas barrier film 61 are arbitrary. However, if the depth of the recessed portion 105 is made equal to or greater than the thickness of the gas barrier film 61, the gas barrier film 61 can be positioned on the case 10 without protruding outward.

In this manner, the structure has the sealing member 60 that defines the flame extinguishing hole 50 while the sealing member 60 sealing the flame extinguishing hole 50. Therefore, it is possible to prevent external siloxane gas or flammable gas outside the case 10 from entering the accommodating space 104 through the flame extinguishing hole 50. Even if flammable gas is present in the accommodating space 104 and ignites, causing a flame to occur, the structure can extinguish the flame.

However, since the gas barrier film 61 seals the accommodating space 104, it is not possible to release water vapor generated within the accommodating space 104 through the flame extinguishing hole 50. Therefore, a moisture-absorbing member 70 is provided within the accommodating space 104.

The moisture-absorbing member 70 only needs to be placed within the accommodating space 104. In this embodiment, the moisture-absorbing member 70 is formed by applying moisture-absorbing materials 71 and 72 to the inner wall surfaces of the case 10 and the base 12. Specifically, a moisture-absorbing material 71 is applied to the entire surface of the case bottom 102 and the four side walls 101 exposed to the accommodating space 104, which is the inner portion beyond where the base 12 is positioned. Additionally, a moisture-absorbing material 72 is applied to the entire surface of the base bottom 121 exposed to the accommodating space 104. Here, the moisture-absorbing material 72 is not applied to the base body 122 of the base 12, but the moisture-absorbing material 72 may also be applied to the base body 122 of the base 12.

The moisture-absorbing materials 71 and 72 are made of, for example, a material in which a desiccant is mixed with resin. For example, as the moisture-absorbing materials 71 and 72, Dry Keep manufactured by Sasaki Chemical Co., Ltd. can be used. Since the moisture-absorbing member 70 is formed by applying the moisture-absorbing materials 71 and 72, it is not necessary to provide the space required for a separate single moisture-absorbing member 70. For example, it is sufficient to apply the moisture-absorbing materials 71 and 72 to the surface of the existing case 10 or base 12 exposed to the accommodating space 104.

In this manner, since the moisture-absorbing member 70 is provided within the accommodating space 104, sealing the flame extinguishing hole 50 with the gas barrier film 61 can suppress the intrusion of siloxane gas and flammable gas. Even if a flame from the flammable gas occurs, it can be extinguished. Additionally, even if water vapor is generated within the accommodating space 104, it can be absorbed by the moisture-absorbing member 70. As a result, even in sub-zero environments, the water vapor is prevented from freezing on the contact surfaces. Therefore, the occurrence of poor contact conductivity due to the influence of siloxane gas or the influence of water vapor present within the accommodating space 104 can be suppressed.

Next, the operation of the electromagnetic relay according to this embodiment will be explained. First, when current is supplied to the coil 18, the electromagnetic force overcomes the return spring 30, causing the movable core 28 to be attracted towards the fixed core 26. Consequently, the mover 36 is urged by the contact pressure spring 38 and moves following the movable core 28. As a result, the two movable contacts 40 come into contact with the two fixed contacts 16, establishing conductivity between the pair of stators 14.

On the other hand, when the power supply to the coil 18 is cut off, the return spring 30 pushes the movable core 28 and the mover 36 against the contact pressure spring 38, urging them away from the fixed core 26. As a result, the two movable contacts 40 are separated from the two fixed contacts 16, interrupting the conductivity between the pair of stators 14.

In an environment where siloxane gas or flammable gas is present around the electromagnetic relay, if the sealing member 60 is not provided, the siloxane gas or flammable gas can enter the accommodating space 104 through the flame extinguishing hole 50. If siloxane gas enters the accommodating space 104, it may cause poor contact. Additionally, if flammable gas flows into the accommodating space 104, it could be ignited by the arc generated between the fixed contacts 16 and the movable contacts 40.

However, by covering the flame extinguishing hole 50 with the sealing member 60, the entry of siloxane gas or flammable gas into the accommodating space 104 through the flame extinguishing hole 50 can be prevented. This not only mitigates poor contact due to the effects of siloxane gas but also reduces the risk of ignition of flammable gas. Additionally, even if the flammable gas present in the accommodating space 104 is ignited by the arc, the heat of the flames are absorbed by the case 10 when they enter the flame extinguishing hole 50. As a result, the flames cannot sustain and are extinguished. Therefore, the propagation of the flames from the ignited flammable gas caused by the arc to the outside of the electromagnetic relay can be prevented, thereby preventing the ignition of any flammable gas present around the electromagnetic relay.

Moreover, since the accommodating space 104 is sealed as an enclosed space by the sealing member 60, if water vapor is generated inside the accommodating space 104, the water vapor cannot be released from the accommodating space 104 to the outside. However, since the accommodating space 104 is equipped with the moisture-absorbing member 70, the moisture-absorbing member 70 can absorb the water vapor. As a result, even in sub-zero environments, the absorption of water vapor prevents it from freezing on the contact surfaces, thereby preventing poor contact conductivity.

### Second Embodiment

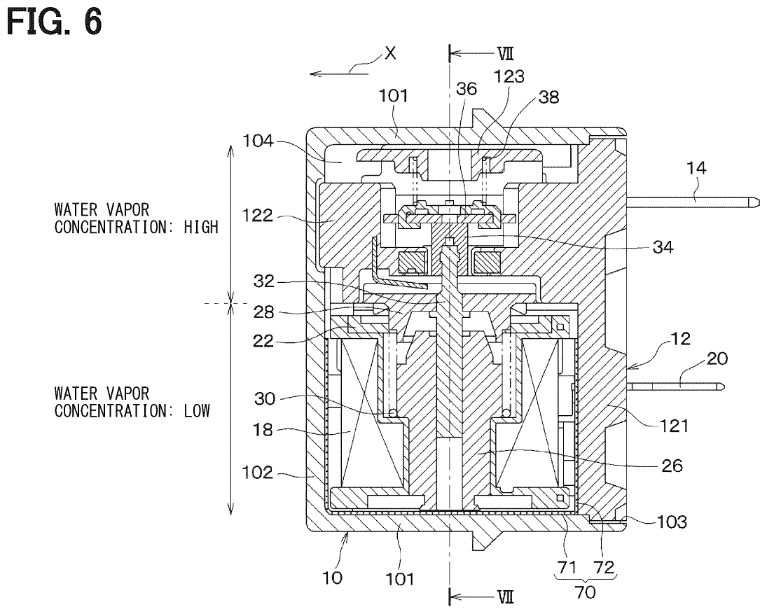

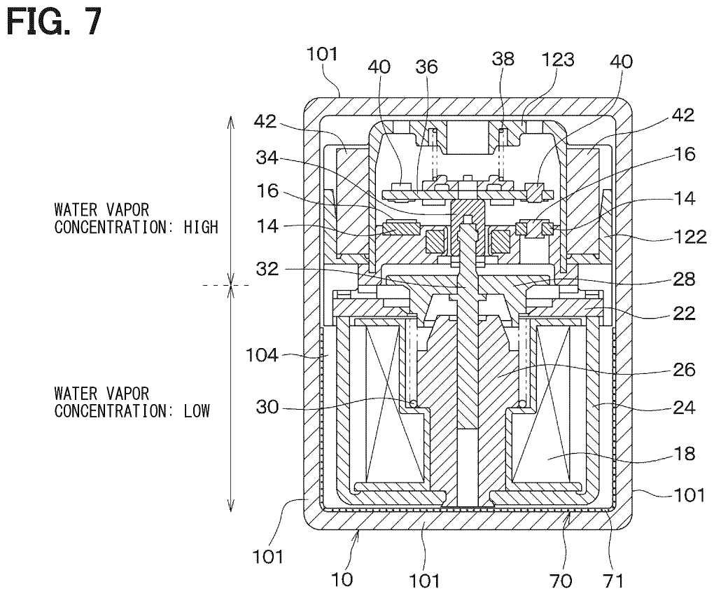

A second embodiment will be described with reference to FIGS. 6 and 7. In the present embodiment, explanations of parts that are similar or equivalent to those in the first embodiment will be omitted or simplified.

As shown in FIGS. 6 and 7, in this embodiment, the location of the moisture-absorbing member 70 is changed compared to the first embodiment.

In the first embodiment, the moisture-absorbing material 71 is applied to the entire surface of the case bottom 102 and the four side walls 101 exposed to the accommodating space 104, which is the inner portion beyond where the base 12 is positioned. Additionally, the moisture-absorbing material 72 is applied to the entire surface of the base bottom 121 exposed to the accommodating space 104. Therefore, the area around the contact portion, which consists of the movable contacts 40 and the fixed contacts 16, is also surrounded by the moisture-absorbing member 70.

In contrast, in the present embodiment, as shown in FIGS. 6 and 7, the moisture-absorbing member 70 is not placed around the contact portion. Instead, the moisture-absorbing member 70 is placed on inner wall surfaces of the case 10 and the base 12 adjacent to the coil 18, which is opposite to the contact portion with respect to the central axis of the electromagnetic relay. Specifically, the moisture-absorbing member 70 is placed on wall surfaces of the case bottom 102, the side walls 101, and the base bottom 121 that define the accommodating space 104. The moisture-absorbing member 70 is placed adjacent to the coil 18 relative to the plate 22, thereby surrounding the coil 18, yoke 24, and fixed core 26.

Thus, a region where the moisture-absorbing member 70 is placed and a region where the moisture-absorbing member 70 is not placed can be provided in the accommodating space 104. When water vapor is generated within the accommodating space 104, it is possible to create a region with high water vapor concentration and a region with low water vapor concentration, as shown in FIGS. 6 and 7. As a result, a water vapor concentration gradient is formed within the accommodating space 104, allowing the water vapor to diffuse from the region with higher concentration to the region with lower concentration. Therefore, the retention of water vapor near the contact portion can be prevented. Thus, even in sub-zero environments, the prevention of water vapor freezing on the contact surfaces can be achieved, thereby preventing poor contact conduction.

Furthermore, by limiting the locations of the moisture-absorbing member 70, it becomes possible to reduce the amount of the moisture-absorbing member 70 used.

### Third Embodiment

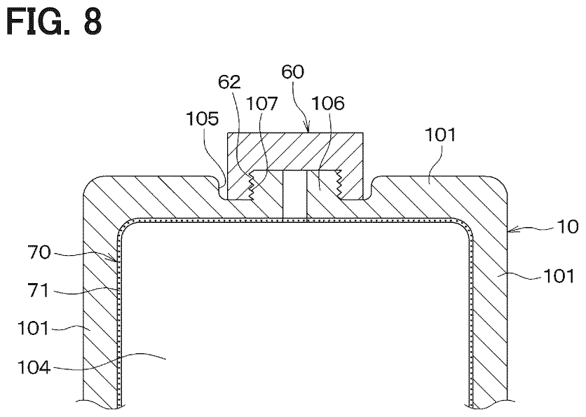

A third embodiment will be described with reference to FIG. 8. In the present embodiment, explanations of parts that are similar or equivalent to those in the first embodiment will be omitted or simplified.

As shown in FIG. 8, in the present embodiment, the structures of the flame extinguishing hole 50 and the sealing member 60 have been modified compared to the first embodiment.

Specifically, for example, the flame extinguishing hole 50 is a cylindrical or polygonal hole, and the sealing member 60 has a screw structure, such that the flame extinguishing hole 50 is located inward of the screw structure of the sealing member 60. The radial dimension and depth of the hole of the flame extinguishing hole 50 are set to dimensions to be capable of extinguishing the flame that has entered the flame extinguishing hole 50. Additionally, the sealing member 60 is a bottomed cylindrical shape with a hollow cylindrical portion, such as a bottomed circular cylindrical shape or a bottomed polygonal shape. Furthermore, a recessed portion 105 and a support wall 106 are provided in the portion of the case 10 surrounding the flame extinguishing hole 50, and a male screw thread 107 is formed on the outer peripheral wall of the support wall 106. A female screw thread 62 corresponding to the male screw thread 107 is formed on the inner wall surface of the sealing member 60 that constitutes the hollow portion.

The sealing member 60 only needs to be capable of suppressing the intrusion of siloxane gas or flammable gas. In other words, the entire sealing member 60 may be made of the same material that can suppress the intrusion of siloxane gas or flammable gas, or it may have a structure where the surface is covered with a gas barrier layer to suppress the intrusion of siloxane gas or flammable gas. When the sealing member 60 is made entirely of the same material, the sealing member 60 can be made of resin such as PBT (polybutylene terephthalate), ceramics, metal such as iron, or other materials. Additionally, when the sealing member 60 has a structure where the surface is covered with a gas barrier layer, the sealing member 60 can be made, for example, of a resin as the base material with the gas barrier layer applied to its surface. In this structure, it is preferable that the entire surface of the sealing member 60 exposed to the outside of the case 10 is covered. However, it is sufficient if at least the outer wall surface of the bottom of the sealing member 60 is covered with a gas barrier layer.

According to such a configuration, by fastening the sealing member 60 to the support wall 106 using the female screw thread 62 and the male screw thread 107, the flame extinguishing hole 50 can be sealed by the sealing member 60. With such a structure, not only can the sealing member 60 be more securely fixed to the case 10, but it also allows for easier attachment of the sealing member 60 to the case 10.

### Other Embodiments

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

For example, in the above embodiments, the case 10 is exemplified as being made of resin, but the case 10 may also be made of metal. Furthermore, in the above embodiments, the base 12 is exemplified as being made of resin, but the base 12 may also be made of ceramic.

Additionally, regarding the shape of the flame extinguishing hole 50, in the first embodiment, it is exemplified as slit-shaped, and in the third embodiment, as cylindrical or polygonal, but the flame extinguishing hole 50 is not limited to these shapes. Furthermore, regarding the location of the flame extinguishing hole 50, in the above embodiments, an example is given where the flame extinguishing hole 50 is formed in one of the side walls 101 of the case 10. However, it may also be formed in other locations, such as the case bottom 102 or the base bottom 121. Additionally, the number of flame extinguishing holes 50 is not limited to one, it may be two or more.

The embodiments described above are not unrelated to each other, and can be appropriately combined unless the combination is obviously impossible.

In the above embodiments, the elements constituting each embodiment are not necessarily essential unless explicitly stated as essential or clearly considered essential in principle.

Additionally, in the above embodiments, when the number, value, quantity, range, etc., of the elements of the embodiment are mentioned, they are not limited to those specific numbers unless explicitly stated as essential or clearly limited to specific numbers in principle.

Additionally, in the above embodiments, when referring to the shape, positional relationship, etc., of the elements, they are not limited to those specific shapes or positional relationships unless explicitly stated or clearly limited to specific shapes or positional relationships in principle.

What is claimed is:

1. An electromagnetic relay comprising:
a case having an accommodating space that is open to an outside through an opening;
a base fitted into the case and closing the opening;
a coil arranged in the accommodating space and configured to generate electromagnetic force when energized;
a pair of fixed contactors each having one end arranged in the accommodating space and fixed to the base;
a movable contactor arranged in the accommodating space and configured to be driven by the electromagnetic force generated by the coil to make or break contact with the pair of fixed contactors, wherein the case or the base has a flame extinguishing hole configured to extinguish a flame, the accommodating space communicating with the outside through the flame extinguishing hole;
a sealing member covering the flame extinguishing hole to make the accommodating space a sealed space and suppress intrusion of gas from the outside to an inside of the accommodating space; and
a moisture-absorbing member arranged in the accommodating space to absorb water vapor within the accommodating space.

2. The electromagnetic relay according to claim 1, wherein
the sealing member is a gas barrier film that is attached to the case or the base, which has the flame extinguishing hole, and covers the flame extinguishing hole.

3. The electromagnetic relay according to claim 1, wherein
the sealing member has a bottomed cylindrical shape with a hollow portion, and has a female screw thread formed on an inner wall surface defining the hollow portion,
the case or the base, which has the flame extinguishing hole, has a support wall around the flame extinguishing hole,
the support wall has a male screw thread corresponding to the female screw thread,
the sealing member is fastened to the support wall via the male screw thread and the female screw thread, and
the flame extinguishing hole is covered by the sealing member.

4. The electromagnetic relay according to claim 1, wherein
the moisture-absorbing member is a moisture-absorbing material that is applied to wall surfaces of the case and the base defining the accommodating space.

5. The electromagnetic relay according to claim 1, wherein
the moisture-absorbing member is a moisture-absorbing material that is applied to inner wall surfaces of the case and the base defining the accommodating space, and
the moisture-absorbing material is not provided in a portion of the inner wall surfaces that surrounds a contact portion including a fixed contact of the fixed contactors and a movable contact of the movable contactor, and
the moisture-absorbing material is provided in a portion of the inner wall surfaces that surrounds the coil and is different from the portion surrounding the contact portion.
